(19) United States
(12) Patent Application Publication
(10) Pub. No.: US 2004/0155777 A1
(43) Pub. Date: Aug. 12, 2004

(54) Apparatus and methods for protecting valuables

(75) Inventors: Christopher Mitchell, North Vancouver (CA); Matthew T. Brown, Vancouver (CA); Hani Mehrpouyan, Port Moody (CA)

Correspondence Address: OYEN, WIGGS, GREEN & MUTALA, 480 - THE STATION, 601 WEST CORDOVA STREET, VANCOUVER, BC, V6B 1G1, CA

(73) Assignee: Stelix Technologies Corp., North Vancouver (CA)

(21) Appl. No.: 10/763,172

(22) Filed: Jan. 26, 2004

Related U.S. Application Data
(60) Provisional application No. 60/441,920, filed on Jan. 24, 2003.

(51) Int. Cl. G08B 13/14

(52) U.S. Cl. 340/568.1

(57) ABSTRACT

A wireless valuables monitoring device, with proximity sensing and automatic arming and disarming features two way communication between the base unit affixed to the valuable and the remote unit carried by the owner. The base unit continuously monitors the position of the remote unit relative to itself to determine when the owner has left the immediate vicinity of the valuable. The base unit alerts the owner upon disturbance of the protected valuable and allows the user to screen for false alarms and be notified of an occurring theft attempt. A soft power switch enables the base unit to be powered off by the unique remote unit to which it belongs.

### CROSS REFERENCE TO RELATED APPLICATION

This application claims priority from U.S. application No. 60/441,920 filed on 24 Jan. 2003, which is hereby incorporated by reference herein.

### TECHNICAL FIELD

The invention relates to apparatus and methods for detecting when an object is disturbed and generating an alarm in response thereto. The invention has general application to protecting valuables. Some embodiments of the invention are applied to protect laptop computers or other portable electronic devices.

### BACKGROUND

The theft or loss of valuable belongings is a problem, especially for those who need to leave or use such valuable belongings in public areas. Valuables may be stolen or tampered with if left unattended even for short periods. A person's valuables can be exposed to risk by common events such as when the person goes to the washroom, takes time away from the office for lunch or coffee, travels by car, bus, train or airplane, or checks into a hotel. Items from purses, briefcases, luggage, wallets, cellular phones, Personal Digital Assistants (PDAs), digital cameras, music players, Liquid Crystal Displays (LCDs), LCD projectors, and laptop computers are just some of the small, but valuable, items that thieves are targeting today.

The theft of a laptop computer can be particularly costly because laptop computers often store information that is confidential and/or very difficult to recreate. More and more laptop computers are used each year as mobile computing replaces conventional desktop computers. Over 100 million laptops are in use worldwide and laptop sales have been continuously increasing. In 2002 alone, notebook computer sales increased by 11% while more portable computers such as PC tablets were introduced to the market. Correspondingly, theft of laptop computers has also been increasing year by year. Last year, more than 640,000 laptops were stolen, resulting in a $60 billion loss in both hardware and stored software and data. Roughly 65% percent of the total thefts occurred on the road and in airports while 29% took place at the office.

Guarding against the theft of portable valuables, and particularly portable computers and other electronic devices is a major issue that has yet to be appropriately addressed. Current anti-theft solutions and theft deterrent systems range from passive devices, such as tethers which can be used to lock a computer to a desk or table, to more complex separation detectors, 2-way signaling devices, and motion alarms.

Motion alarms can be triggered by an authorized user of the device if the user forgets to disarm the motion alarm before moving the valuable.

2-way signaling devices extend the capability of monitoring a valuable further by allowing a user to screen signals and get feedback from the valuable. However, these devices are often complex and are undesirably hard to use.

Scholder, U.S. Pat. No. 5,578,991 discloses a security system for a portable personal computer. The security system includes a sensor which detects when the computer is moved away from an object, such as the surface of a table on which the computer is sitting. The sensor is connected to trigger an alarm.

Andrews U.S. Pat. No. 5,757,271 discloses a security system for a portable computer. A security device detects whether or not a second electronic device is nearby. In response to a detection that the second electronic device is not nearby a signal is generated indicating that a security violation has occurred. In one embodiment, wireless signals having an effective range equal to the selected proximity are transmitted from the second electronic device to the first electronic device. The security device determines that the first electronic device is not within the selected proximity of the second electronic device in response to a failure to receive the wireless signals.

D'Angelo, et al. U.S. Pat. No. 5,963,131 discloses a motion sensitive theft detector system for portable articles featuring two way communication between the theft detector unit installed in or affixed to a portable article and a control unit carried by the owner. The theft detector communicates alerts to the control unit allowing the user to screen for false alarms and to trigger an alarm at the portable article when warranted.

D'Angelo, et al. U.S. Pat. No. 6,133,830 discloses a motion sensitive theft detector system for portable articles featuring two way communication between the theft detector unit installed in or affixed to the portable article and the control unit carried by the owner. The theft detector communicates alerts to the control unit allowing the user to screen for false alarms and to trigger an alarm at the portable article when warranted.

There remains a need for practical cost effective theft-deterrent devices and methods.

### SUMMARY OF THE INVENTION

One aspect of the invention provides a valuables monitoring system. The system comprises a disturbance detection mechanism comprising one or more sensors configured to generate a disturbance signal upon disturbance of an item being monitored; an alarm connected to be triggered by the disturbance signal; and a receiver configured to receive a wireless signal from a remote unit. An alarm inhibition mechanism is connected to selectively inhibit operation of the alarm. The alarm inhibition mechanism includes a mechanism responsive to signals from the remote unit received at the receiver to automatically inhibit the alarm if the received signals indicate that the remote unit is nearby.

Another aspect of the invention provides a method for monitoring an item. The method comprises providing a base unit attached to the item and a remote unit; detecting a proximity of the remote unit to the base unit and inhibiting an alarm if the remote unit is determined to be nearby the base unit. The alarm is triggered in response to a disturbance of the base unit unless the alarm is inhibited.

Further aspects of the invention and features of specific embodiments of the invention are described below.

### BRIEF DESCRIPTION OF THE DRAWINGS

In drawings which illustrate non-limiting embodiments of the invention,

FIG. 1 is a block diagram of apparatus according to a basic embodiment of the invention;

FIG. 1A is a block diagram of apparatus more fully featured than the apparatus of FIG. 1;

FIG. 2 is a flowchart illustrating a process performed at a base unit of one embodiment of the invention;

FIG. 3 is a flowchart illustrating a process performed at a remote unit cooperating with a base unit operating under the process of FIG. 2;

FIG. 4 is a schematic illustration showing a base unit having a locking mechanism for locking the base unit to an item to be protected;

FIG. 5 is a flow chart illustrating a process for turning on a base unit in some embodiments of the invention; and,

FIG. 6 is a flow chart illustrating a process for turning on a remote unit and turning off both a remote unit and a corresponding base unit in some embodiments of the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

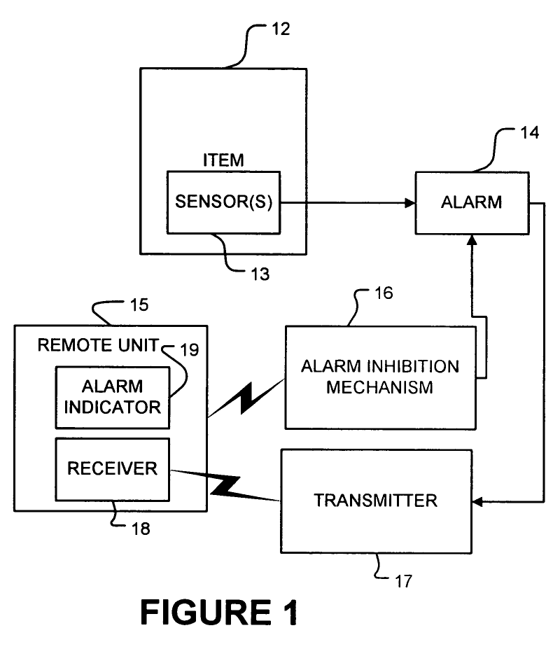

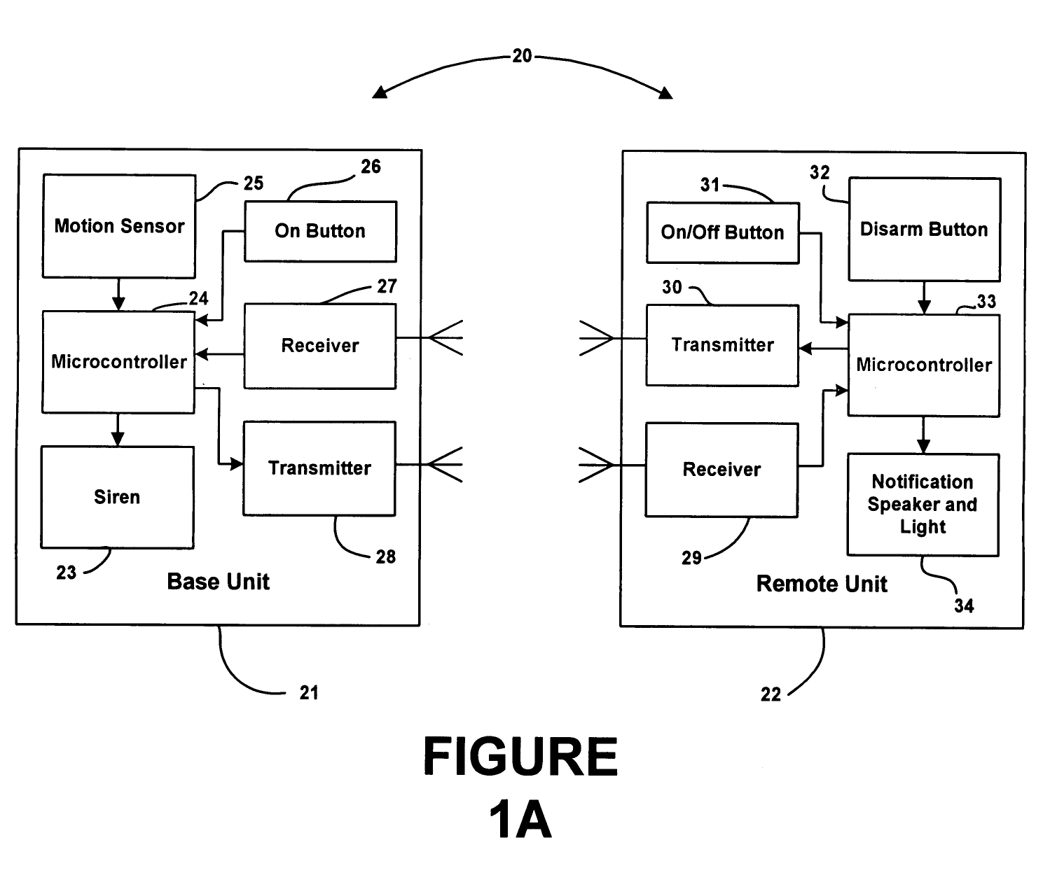

The invention will be described with reference to example systems and methods for alerting a person when an item in their charge is tampered with and/or moved. Apparatus 10 according to a general embodiment of the invention is shown in FIG. 1. A valuable item, 12 for example, a portable computer, is equipped with one or more sensors 13. Sensors 13 detect disturbance (e.g. movement or tampering) of item 12. In some embodiments of the invention, sensor 13 comprises one or more tilt sensors, accelerometers, touch sensors, optical sensors or the like.

An alarm 14 is coupled to receive signal(s) from sensor 13. The alarm is triggered when sensor 13 generates a disturbance signal which indicates that item 12 is being disturbed (e.g. tampered with and/or moved). The alarm is inhibited when a wireless signal from a remote unit 15 indicates that the remote unit is near to item 12. In the embodiment of FIG. 1, an alarm inhibition mechanism 16 receives a wireless signal from remote unit 15. As long as the wireless signal indicates that remote unit 15 is nearby (for example, as long as the signal is stronger than a threshold value) alarm inhibition mechanism 16 inhibits alarm 14. Alarm inhibition mechanism 16 may comprise, for example, an electronic circuit; a software process being executed by a data processor; or some combination thereof.

In some embodiments of the invention, apparatus 10 includes a transmitter 17 that transmits a notification signal to a receiver 18 in remote unit 15 when alarm 14 is triggered. In such embodiments, receiver 18 may be connected to trigger an alarm indicator 19 when the notification signal is detected. Alarm indicator 19 may comprise an audible, visual or tactile warning device, for example.

Apparatus 10 can be used simply. A user can keep remote unit 15 on his or her person. While the user remains near item 12, alarm inhibition mechanism responds to the proximity of remote unit 15 and inhibits the operation of alarm 14. The user can move and use item 12 without raising an alarm. If the user leaves the vicinity of item 12, alarm inhibition mechanism 16 ceases to inhibit the operation of alarm 14. While the user remains away from the immediate vicinity of item 12, any disturbance detected by sensors 13 will trigger alarm 14. If apparatus 10 includes a mechanism for transmitting a notification signal to remote unit 15 then alarm indicator 19 warns the user that an alarm has been triggered, even if the user is not in the immediate vicinity of item 12.

An advantage of this embodiment of the invention is that the operation of apparatus 10 is simple for the user. The user does not need to manually arm and disarm apparatus 10 to switch alarm 14 between its enabled and disabled modes.

The components of apparatus 10 that are collocated with item 12 may be integrated with item 12 or may be combined in a base unit which can be attached to item 12.

FIG. 1A shows a system 20 according to a more fully featured embodiment of the invention. System 20 includes a base unit 21 and a remote unit 22. Remote unit 22 may be carried by a user. Base unit 21 may be affixed to a valuable to be protected.

Base unit 21 includes a control circuit, which may conveniently comprise a microcontroller 24. Microcontroller 24, may comprise a suitable microcontroller chipset that allows for software programs to be stored and executed. In the alternative, the control circuit could comprise logic circuits which are configured specifically to provide one or more of the functions described herein. Such logic circuits could be provided on an application specific integrated circuit (ASIC), a field programmable gate array (FPGA) or by way of discrete components, for example.

In the embodiment of FIG. 1A, microcontroller 24 includes a clock, a central processing unit (CPU), random access memory (RAM), and read only memory (ROM) which may be on one or more chips. Base unit 21 also includes a motion sensor circuit 25, an alarm circuit 23, an ON control 26, and a two-way wireless communication mechanism.

In the illustrated embodiment, the communication mechanism comprises an RF transceiver which includes a transmitter 28 and a receiver 27. The transmitter 27 and receiver 28, can be provided conveniently by the transmitter and receiver portions of a commercially available RF transceiver. These components could also be made up of discrete components. Any suitable communication protocol may be used for signalling between base unit 21 and remote unit 22. In some embodiments, digital data is exchanged between base unit 21 and remote unit 22. In some embodiments data is communicated by sending a low power RF signal that includes preamble data bits that allow other receivers to lock onto the frequency of transmission of transmitter 28, an identifier comprising a sequence of bits unique to one remote unit 22, and instruction bits which remote unit 22 can process.

Motion sensor circuit 25 includes one or more sensors. The sensors may include one or more:

tilt switches;

vibration sensors;

accelerometers;

proximity detectors;

capacitive sensors;

mechanical switches located to change state when the base unit is lifted away from a surface on which it is sitting;

light detectors; and/or

other sensors or combinations of sensors capable of generating an output signal indicative that base unit 21 is being moved, tampered with of otherwise disturbed.

An disturbance signal from motion sensor circuit 25 is provided to microcontroller 24. Any suitable mechanism may be used to provide the disturbance signal to microcontroller 24. For example, sensor circuit 25 could be configured to:

set a flag, for example by writing a value to a data register;

trigger an interrupt sequence in the microcontroller 24;

set a control line to a current or voltage level indicative of an alarm condition;

or the like.

Siren circuit 23, includes any suitable audible and/or visual alarm generator together with any necessary driving circuits.

ON control 26, may comprise a pushbutton or other input mechanism coupled to a circuit which causes base unit 21 to power up.

Remote unit 22 includes a control circuit. The same general design options available for the control circuit of base 21 are also available for the control circuit of remote unit 15. In the illustrated remote unit 22 a microcontroller 33 provides control functions.

Remote unit 22 also includes a notification circuit 34, an ON/OFF control 31, a DISARM control 32, and a two-way wireless communication mechanism compatible with the wireless communication mechanism of base unit 21. In the illustrated embodiment, the communication mechanism of remote unit 22 comprises a transmitter 30 capable of broadcasting a wireless signal which can be received by receiver 27 of base unit 21 and a receiver 29 capable of receiving signals broadcast by transmitter 28 of base unit 21.

The signals exchanged by the wireless communication mechanism are preferably encoded. The use of encoded signals allows several systems 20 to operate in the same vicinity even if the wireless communication mechanisms of the systems operate at the same frequencies. Encoding and decoding of signals exchanged between remote unit 22 and base unit 21 may be performed by microcontrollers 24 and 33 or, in the alternative, by separate encoder/decoder systems. Microcontrollers 24 and 33 may be configured to ignore signals that are not encoded in the manner associated with the corresponding unit 21 or 22.

Wireless communications between a remote unit 21 and a base unit 22 may be carried by radio frequency signals. A suitable frequency-hopping algorithm may be used to reduce the likelihood of interference with signals from other systems 20 or other devices operating in a frequency range of the radio frequency signals. Various suitable frequency-hopping systems are known to those skilled in the art of radio frequency communications.

Notification circuit 34 comprises a device for alerting a user carrying remote unit 22. Remote unit 22 may include a sound-emitting device such as a speaker or buzzer, a light emitting device, a tactile device, such as a vibrator, and any circuitry necessary to drive the device.

ON/OFF control 31 and DISARM control 32 each comprise a suitable input mechanism, such as a pushbutton, which can be activated by a user.

When system 20 is off, it can be turned on by actuating ON control 26 on base unit 21 and actuating ON/OFF control on remote unit 22. It is noteworthy that, in the illustrated embodiment, there is no control on base unit 21 for turning system 20 off. System 20 can be turned off by actuating ON/OFF control 26 of remote unit 15. This makes it difficult for a malicious individual to interfere with the proper operation of system 20 by turning off base unit 21.

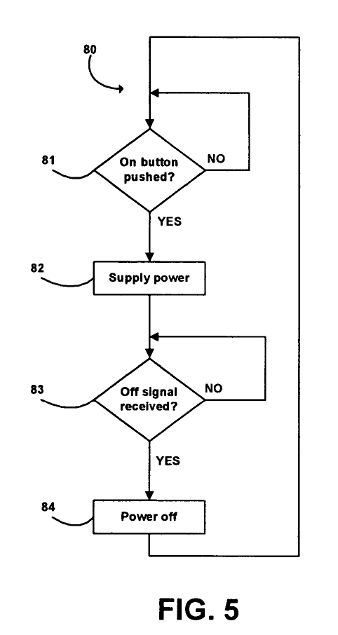

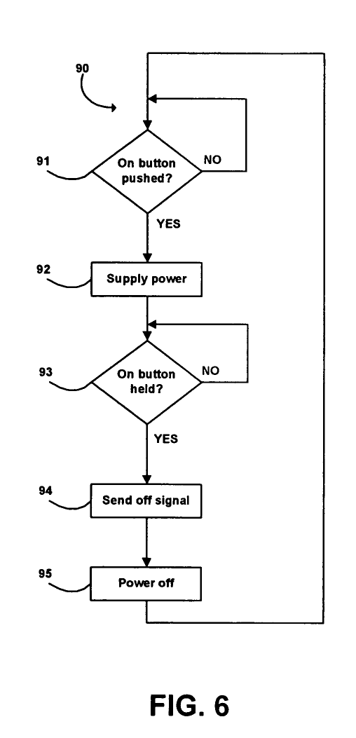

System 20 may include a soft switch mechanism which controls switching both remote unit 22 and the base unit 21 between their active modes and standby modes. The soft switch mechanism may use both software and hardware circuitry to accomplish its task. FIGS. 5 and 6 illustrate methods performed by an example embodiment of such a soft switch mechanism at the base unit and remote unit respectively. As shown in FIG. 5, activating ON control 26 moves process 80 from block 81 to block 82. Block 82 causes power to be supplied to microcontroller 24 and other circuits of base unit 21. After process 80 has left block 81, activating the ON control 26 additional times has no effect. Process 80 then waits to receive an off signal 83 from remote unit 22. When an OFF signal (encoded in the expected manner) is received by way of receiver 27, process 80 moves to block 84 which causes power to microcontroller 24 and other circuits of base unit 21 to be being turned off. Base unit 21 can be turned off only by way of remote unit 22.

FIG. 6 illustrates a process 90 which is invoked when remote unit 22 is off and ON/OFF control 31 is actuated by a user in block 91. Operation of ON/OFF control 31 causes power to be supplied to microcontroller 33 and other circuits of remote unit 22 in block 92. Process 90 then moves to block 93 where it remains until the user operates ON/OFF control 31 again. Preferably, block 93 requires the user to keep ON/OFF control 31 actuated for at least a short while. This reduces the likelihood that the user could accidentally turn system 20 off.

When block 93 detects that ON/OFF control 31 has been actuated for a sufficient time, process 90 moves to block 94. The exact time for which ON/OFF control 31 must be actuated is not critical. The time is chosen to be longer than any anticipated accidental actuations of ON/OFF control 31. In block 94, process 90 sends an OFF signal to base unit 21 by way of transmitter 30 (assuming that base unit 21 is on and process 80 is on block 83 the OFF signal causes base unit 21 to turn off). Process 90 then completes at 95 by turning the power off to remote unit 22.

When system 20 is operating, programs running on microcontrollers 24 and 33 cause signals to be exchanged periodically between base unit 21 and remote unit 22. From the signals received at base unit 21, microcontroller 24 can determine when remote unit 22 is nearby. The signals sent by base unit 21 to remote unit 22 may include signals which indicate that sensor system 25 has detected disturbance. The signals sent by remote unit 22 to base unit 21 may include OFF signals, and/or other control signals.

During normal operation, each of remote unit 22 and base unit 21 expect to periodically receive a coded signal from the other every so often.

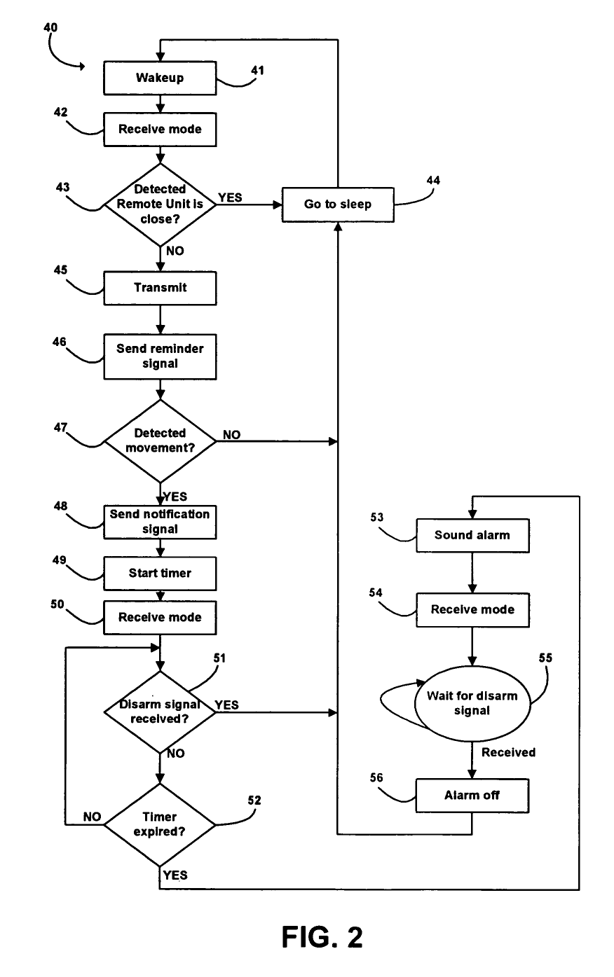

FIG. 2 illustrates a flowchart for an operating process 40 performed by microcontroller 24 of base unit 21 in one embodiment of the invention. Process 40 commences at block 41 when microcontroller 24 is either powered up or woken up from a low-power idle mode. Once microcontroller 24 is activated, process 40 proceeds to step 42 where receiver 27 is set to receive mode for a short period of time. While receiver 27 is in receive mode, microcontroller 24 processes any received bits and checks to see if a valid signal from the corresponding remote unit 22 has been received. If such a signal is received then block 43 uses the signal to determine whether or not remote unit 22 is nearby.

Block 43 may include generating a request signal at transmitter 28 which, when received by remote unit 22 causes remote unit 22 to automatically transmit a ranging signal. The ranging signal may be used by base unit 21 to determine whether or not remote unit 22 is nearby as described above.

Various methods can be used to determine whether remote unit 22 is nearby. These include:

Sending a low power ranging signal from remote unit 22 to base unit 21. If the low power signal is successfully received then block 43 concludes that remote unit 22 is nearby. If the low power signal is not received then block 43 concludes that remote unit 22 is not nearby. The power of the low-power signal sent by remote unit 22 and/or the sensitivity of receiver 27 may be set to adjust the maximum distance at which the low-power signal can be received by base unit 21. The low power ranging signal may have the same or a different power level than other signals exchanged between base unit 21 and remote unit 22.

At base unit 21 measuring the strength of a signal originating from remote unit 22 and comparing the measured signal strength to a threshold value. Since signal strength falls off with distance, the remote unit 22 can be considered to be nearby if the signal strength exceeds the threshold value. Any or all of the threshold value, the strength of the transmitted signal, and an attenuation of the received signal prior to measuring the signal strength may be varied to adjust the maximum distance at which the received signal strength can exceed the threshold.

If block 43 determines that the remote unit is nearby then process 40 proceeds to sleep 44. In the alternative, if process 40 does not determine that the remote unit 22 is nearby then process 40 proceeds to block 45. In block 45, base unit 21 sends a reminder signal to remote unit 22 the reminder signal is sent by way of transmitter 28. When remote unit 22 receives the reminder signal, microcontroller 33 causes a reminder action to be generated at remote unit 22. The reminder action may comprise generating a tone or other audible signal, flashing or blinking an indicator light, vibrating slightly or the like. The reminder action reminds the person carrying remote unit 22 that the base unit 21 and associated valuable have been left behind. This feature enables the user to be notified with a subtle beep or visual queue once they are separated from their valuable, in case they simply forgot to bring it with them.

Process 40 now proceeds to block 47. In block 47 microcontroller commences monitoring the output of sensor system 25 for signals indicative that base unit 21 has been moved or tampered with.

If no motion or tampering is detected, process 40 goes back to sleep in block 44.

If motion or tampering is detected in block 47, base unit 21 sends a notification signal by way of transmitter 28. The notification signal is received by remote unit 22 if remote unit 22 is not too far away. When remote unit 22 receives the notification signal, remote unit 22 generates a notification action distinct from the reminder action. The notification action may comprise an audio, visual or tactile signal or a combination thereof.

Base unit 21 also initiates a timer (block 49) in response to detecting the motion or tampering. The timer provides the person who has remote unit 22 with an opportunity to disarm base unit 21 before alarm 23 sounds, and thereby avoid an undesired alarm from being issued by base unit 21. Process 40 then places base unit 21 in receive mode (block 50) and loops around blocks 51 and 52 until the timer expires or a DISARM signal is received from remote unit 22. If block 51 detects a DISARM signal before the timer expires then process 40 proceeds to sleep 44. If block 52 determines that the timer has expired then process 40 proceeds to block 53 which activates siren 23.

After turning on siren 23, process 40 causes receiver 27 to listen for a DISARM signal from remote unit 22 in block 55. When the DISARM signal is received then base unit 21 turns siren 23 off at block 56. After turning the siren off, microcontroller 24 and transceiver (27 and 28) enter sleep mode once again at 44.

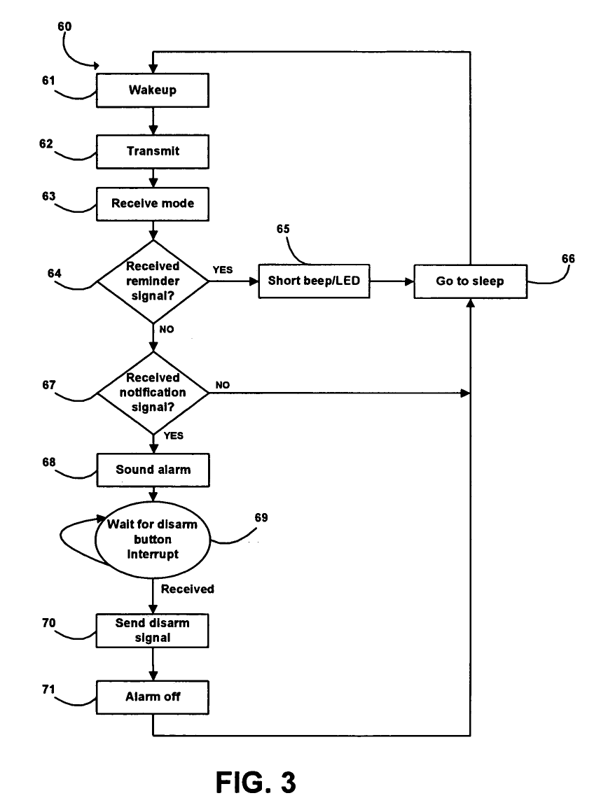

Process 40 operates on base unit 21 which operates in conjunction with remote unit 22. A software program executing on microcontroller 33 may coordinate the operation of remote unit 22. A process 60 that may be followed by such a program is illustrated in Figure FIG. 3. Process 60 commences at block 61 where microcontroller 33 is either powered up or woken up from a low power idle mode.

Process 60 then proceeds to block 62 wherein it controls transmitter 30 to transmit a RF signal at low power and then proceed immediately to place receiver 29 into receive mode at block 63. If, during this receive mode, receiver 29 detects a reminder signal from base unit 21, as indicated by block 64 then process 60 proceeds to block 65 which generates the reminder action (e.g. a short indicator from notification circuit 34). Process 60 then proceeds to block 66 which causes microcontroller 33 to go to sleep 66.

If block 67 determines that a notification signal has been received (i.e a signal indicating that movement or tampering have been detected at base unit 21 then process 60 proceeds to block 68. At block 68, the notification action is performed (e.g. notification circuit 34 is turned fully on).

After the notification action has been initiated, process 60 checks in block 69 to see if the user has actuated DISARM control 32. If so, then a DISARM signal is sent by way of transmitter 30 at block 70. The notification action is discontinued at block 71. If block 69 does not detect that the user has actuated DISARM control 32 then process 60 remains at block 69.

Base unit 12 may be associated with a valuable item to be protected in any of various ways. For example, in various embodiments:

Base unit 21 includes a lock which allows it to be physically attached to devices like laptops, liquid crystal display monitors, and projectors. The lock may engage a security slot (one example being a Kensington slot), a PC card interface of a computer, a PC Universal Serial Bus port of a computer, a floppy disk drive of a computer or the like.

Base unit 21 is integrated into a valuable item to be protected—for example as part of a motherboard of a laptop computer. or

Base unit 21 is affixed to a valuable item to be protected with a fastening means such as screws, bolts, rivets, an adhesive, or the like.

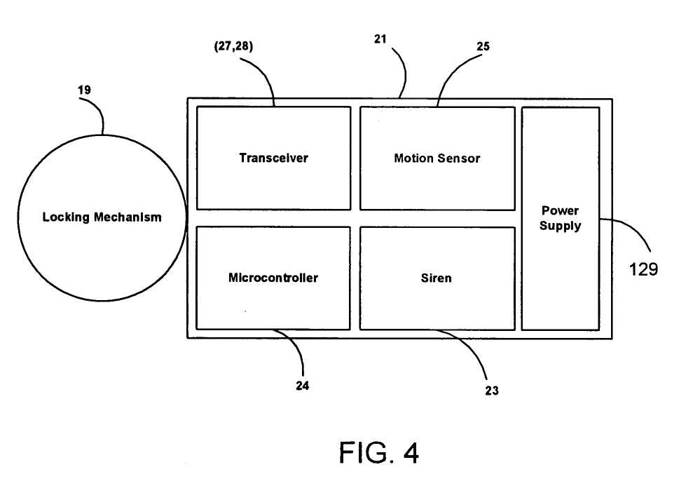

FIG. 4 shows a base unit 21 having a locking mechanism 19 according to one embodiment of the invention. Locking mechanism 19 may comprise a cable lock and may be adapted to lockingly engage a security slot of the type sometimes provided on laptops, LCDs, and LCD projectors and the like.

Base unit 21 and remote unit 22 may each have an internal power supply 129, typically a battery. In many applications of the invention it is desirable to make base unit 21 and remote unit 22 lightweight for easy portability. In such cases power management is important because there is a limit to the capacity of lightweight batteries. Power consumption can be minimized, by having microcontrollers 24 and 33 spending significant proportions of the time in sleep modes.

There are a wide range of suitable mechanisms for causing a microcontroller to wake up periodically from a low power (or “sleep”) mode to perform a necessary process and then return to the low power mode. For example:

A software timer may operate while the processor is in sleep mode. The software timer may interrupt the microcontroller (24, 33) when it is time to wake up.

A separate timer, such as a digital logic counter coupled to a system clock may be connected to pass an elapsed time signal to the microcontroller or to another part of the circuit. For example, a microcontroller might set the timer to expire after a certain period of time. Upon the time period ending the timer could cause a flag to be set or send a signal to some circuitry indicating that time has expired.

By operating microcontrollers and/or other circuits at full power only some of the time, overall power consumption can be significantly reduced. In some cases, power can be on less than half of the time, and in another case it can be on for only a quarter of the time, and in yet another case can be on for less than an eighth of the time, and so on.

Power can further be conserved by operating transceivers of the base unit and remote unit to exchange information according to a protocol that minimizes the amount of time that the transceivers are operating and especially minimizes transmitting operations.

Certain implementations of the invention comprise computer processors which execute software instructions which cause the processors to perform a method of the invention. For example, one or more processors in a base unit may implement the methods of FIG. 2 by executing software instructions in a program memory accessible to the processors. The invention may also be provided in the form of a program product. The program product may comprise any medium which carries a set of computer-readable signals comprising instructions which, when executed by a computer processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, PROMS, EPROMS, flash RAM, or the like or transmission-type media such as digital or analog communication links.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example:

Alarm inhibition circuit 16 could inhibit triggering of alarm 14 or, in the alternative, could inhibit the effect of alarm 14, for example, by silencing audible warnings and/or disabling visual alarm displays provided by alarm 14.

In addition to sounding an alarm upon a possible theft attempt, base unit 21 could be configured to activate or protect the valuable further by locking down peripherals of a laptop, encrypting data, connecting to a global positioning system in order to track the valuable or the like.

The invention is not limited to use in protecting inanimate valuable items. The methods and components described herein may also be used for monitoring pets or children. For example, a base unit 21 could be incorporated into a bracelet to be worn by a child or a collar to be worn by a pet.

The signals exchanged between a base unit and a remote unit do not need to be radiofrequency signals. Other types of wireless signals, such as ultrasonic signals could be used in the alternative.

It is not mandatory that the same type of signals used to carry information (e.g. OFF signals, DISARM signals, REMINDER signals, NOTIFICATION signals) be used to determine when remote unit 22 is near to base unit 21. For example, an ultrasonic signal could be used for ranging while radiofrequency signals are used to carry information receivers in the base and/or remote units may include receivers for different signal types.

Signals used to carry information between a base unit and remote unit may have different strengths, frequencies, formats etc. from signals used to determine when the corresponding remote unit is nearby to a base unit. In some embodiments low strength ranging signals are used for determining whether the remote unit is nearby to the base unit and some or all of the information carrying signals have significantly greater ranges than the ranging signals.

Ranging signals could also be used to carry information between a base unit and a remote unit or vice versa.

In some of the embodiments described above, a low strength ranging signal is sent from the remote unit to the base unit. The base unit knows that the remote unit is nearby if it receives the low strength ranging signal. The invention could also be practised by sending a low strength ranging signal from the base unit to the corresponding remote unit. The remote unit could be configured to generate a reply signal upon detecting the low strength ranging signal. In such embodiments the base unit would know that the remote unit is nearby if it receives reply signals in response to its low strength ranging signals.

ON/OFF control 31 may be replaced with separate ON and OFF controls.

The frequencies of signals used by a system do not need to be fixed. The system may have the capability to vary the operating frequency to prevent interference from other products working in the same RF band or signal frequency.

Accordingly, the scope of the invention is to be construed in accordance with the substance defined by the following claims.

What is claimed is:

1. A valuables monitoring system comprising:
a disturbance detection mechanism comprising one or more sensors configured to generate a disturbance signal upon disturbance of an item being monitored;
an alarm connected to be triggered by the disturbance signal;
a receiver configured to receive a wireless signal from a remote unit;
an alarm inhibition mechanism connected to selectively inhibit operation of the alarm, the alarm inhibition mechanism including a mechanism responsive to signals from the remote unit received at the receiver to automatically inhibit the alarm if the received signals indicate that the remote unit is nearby.

2. A valuables monitoring system according to claim 1 wherein the disturbance detection mechanism, alarm, receiver and alarm inhibition mechanism are packaged in a base unit and the system comprises a lock for attaching the base unit to the item being monitored.

3. A valuables monitoring system according to claim 2 comprising a connector for attaching the base unit to a security slot of the item.

4. A valuables monitoring system according to claim 2 wherein the item comprises a computer and the base unit comprises an interface for coupling the base unit to a PC card interface of the computer.

5. A valuables monitoring system according to claim 2 wherein the item comprises a computer and the base unit comprises an interface for coupling the base unit to a universal serial bus port of the computer.

6. A valuables monitoring system according to claim 1 wherein the disturbance detection mechanism, alarm, receiver and alarm inhibition mechanism are integrated within the item being monitored.

7. A valuables monitoring system according to claim 1 comprising a timer connected to delay the application of the disturbance signal to the alarm by a delay period.

8. A valuables monitoring system according to claim 7 wherein the base unit is configured to detect DISABLE signals originating at the remote unit and to disable the alarm upon receipt of a DISABLE signal.

9. A valuables monitoring system according to claim 1 wherein the base unit comprises a transmitter and is configured to transmit a notification signal upon occurrence of the disturbance signal.

10. A valuables monitoring system according to claim 4 wherein the base unit is configured to detect OFF signals originating at the remote unit and to turn itself off upon receipt of an OFF signal.

11. A valuables monitoring system according to claim 1 wherein the receiver comprises a radiofrequency receiver.

12. A valuables monitoring system according to claim 1 comprising a mechanism for comparing a strength of the wireless signal to a threshold, wherein the alarm inhibition mechanism is configured to inhibit the alarm while the strength of the wireless signal exceeds the threshold.

13. A valuables monitoring system according to claim 1 comprising a transmitter and a mechanism responsive to the receiver for causing the transmitter to send periodic REMINDER signals if received signals do not indicate that the remote unit is nearby.

14. A valuables monitoring system according to claim 1 wherein the alarm inhibition mechanism comprises a microcontroller interfaced to the disturbance detection mechanism, alarm and receiver.

15. A valuables monitoring system according to claim 2, wherein the base unit lacks an external control for turning off the base unit.

16. A valuables monitoring system according to claim 2 wherein the wireless signal is encoded in a manner associated with the remote unit and the base unit includes a decoder configured to decode and pass wireless signals encoded in the manner associated with the remote unit.

17. A method for monitoring an item, the method comprising:
providing a base unit attached to the item and a remote unit;
detecting a proximity of the remote unit to the base unit and inhibiting an alarm if the remote unit is determined to be nearby the base unit;
detecting a disturbance of the base unit and, in response to the disturbance triggering the alarm unless the alarm is inhibited.

18. A method according to claim 17 comprising waiting for an interval after detecting the disturbance before triggering the alarm.

19. A method according to claim 18 comprising sending a notification signal from the base unit to the remote unit upon detecting the disturbance.

20. A method according to claim 19 comprising, at the remote unit, receiving the notification signal and performing a notification action detectable by a person carrying the remote unit in response to the notification signal.

21. A method according to claim 20 comprising, at the remote unit, receiving a control input and, in response to the control input transmitting a DISABLE signal, and, at the base unit, receiving the DISABLE signal and deactivating the alarm in response thereto.

22. A method according to claim 17 comprising periodically transmitting a REMINDER signal from the base unit if the remote unit is determined to be not nearby to the base unit.

23. A method according to claim 22 comprising, at the remote unit, receiving the REMINDER signal and performing a reminder action detectable by a person carrying the remote unit in response to the REMINDER signal.

24. A method according to claim 17 wherein detecting the proximity of the remote unit comprises measuring at the base unit a strength of a ranging signal transmitted by the remote unit.

25. A method according to claim 24 comprising adjusting a strength of the ranging signal to vary a size of a region within which the remote unit is determined to be nearby to the base unit.

26. A method according to claim 17 wherein detecting the proximity of the remote unit comprises detecting at the base unit a ranging signal transmitted by the remote unit.

27. A method according to claim 26 comprising transmitting the ranging signal automatically upon receipt at the remote unit of a request signal from the base unit.

28. A method according to claim 26 wherein the request signal has a range greater than a range of the ranging signal.

29. A method according to claim 26 comprising adjusting a strength of the ranging signal to vary a size of a region within which the remote unit is determined to be nearby to the base unit.

30. A method according to claim 17 wherein detecting the proximity of the remote unit comprises transmitting a ranging signal from the base unit and, in response to detection of the ranging signal at the remote unit, automatically transmitting a reply signal.

31. A method according to claim 17 wherein detecting the proximity of the base unit to the remote unit comprises exchanging one or more radio frequency signals between the base unit and the remote unit and the method comprises varying a frequency of the radio frequency signals according to a frequency-hopping algorithm.
